(19) United States
(12) Patent Application Publication
(10) Pub. No.: US 2025/0183758 A1
(43) Pub. Date: Jun. 5, 2025

(54) SYSTEM FOR GENERATING ELECTRICAL ENERGY IN A LINEAR MOTION DEVICE

(71) Applicant: Schneeberger Holding AG, Roggwil (CH)

(72) Inventors: Peter HAEFNER, Neuenbuerg (DE); Klaus-Dieter GOETZ, Sersheim (DE)

(73) Assignee: Schneeberger Holding AG, Roggwil (CH)

(21) Appl. No.: 18/960,113

(22) Filed: Nov. 26, 2024

(30) Foreign Application Priority Data
Dec. 4, 2023 (EP) 23214073.1

(51) Int. Cl. H02K 7/18; H02K 35/04

(52) U.S. Cl. CPC H02K 7/1876; H02K 35/04

(57) ABSTRACT

A system for generating electrical energy generates electrical energy in a linear motion device having a first component and a second component supported by rollers thereon to enable the second component to be moved linearly relative to the first component. The system includes: the rollers moveable along a movement direction during linear motion device operation; a generator for generating a static magnetic field in a spatial region, which the rollers must successively traverse while moving along the movement direction. The rollers include a magnetically permeable material influencing the magnetic field depending on roller position in the region; and at least one induction coil with at least one winding arranged stationarily relative to the magnetic field generator so that a change in roller position through the region along the movement direction causes a magnetic flux change in the coil, which induces an electric voltage in the at least one winding.

### CROSS REFERENCE TO RELATED APPLICATIONS

Applicant claims priority under 35 U.S.C. § 119 of European Application No. 23214073.1 filed Dec. 4, 2023, the disclosure of which is incorporated by reference.

### BACKGROUND OF THE INVENTION

### 1. Field of the Invention

The present invention pertains to a system for generating electrical energy in a linear motion device that has a first device component and a second device component, wherein the second device component is supported on the first device component by means of rolling elements such that the second device component is configured to be moveable linearly relative to the first device component. Furthermore, the present invention also pertains to a linear motion device equipped with such a system, e.g. to a profiled rail guide with rolling elements that are arranged between a first device component and a second device component being moveable relative to the first device component.

### 2. Description of the Related Art

A linear motion device is a mechanical system constructed for realizing linear motions with minimized friction and high precision. This device combines a (e.g. stationary) first device component with a second device component that can be moved relative to the first device component, wherein the specific properties and characteristics of these two components are variable.

In an embodiment of a linear motion device that is designed in the form of a profiled rail guide, the first device component consists, for example, of a metallic guide rail. This rail can have different profiles depending on the specific design and the technical requirements. It acts as a robust sliding and reference surface for the guide carriage. In the case of the profiled rail guide, the guide carriage, which is alternatively also referred to as guide block, moves along the guide rail. It therefore forms a movable device component. Depending on its specific design, this guide carriage can have different shapes and be used for different purposes such as for transporting loads.

An alternative embodiment of a linear motion device is a ball screw, in which a precision-machined spindle with a special spiral profile serves as the stationary device component. The spindle acts as a guide element, as well as a drive element, for a movable device component, namely the spindle nut. In such a ball screw, which represents an efficient method for converting a rotary motion into a linear motion, the spindle nut corresponds to the profile of the spindle and moves linearly along this profile when the spindle rotates.

One characteristic feature of many linear motion devices of this type is the integration of rolling elements. These rolling elements may be realized in the form of balls or rollers and are strategically positioned between the movable and the stationary device component in order to effectively reduce friction. The rolling elements in profiled rail guides roll between the guide carriage and the guide rail whereas the rolling elements in ball screws act between the threads of the spindle and the spindle nut in order to thereby convert a rotary motion into a linear motion.

Many modern applications of linear motion devices utilize sensors that may be arranged, for example, on a movable device component such as the guide carriage of a profiled rail guide. These sensors typically require electrical energy. In order to supply the sensors arranged on a guide carriage with electrical energy, it is common practice, for example, to supply the energy from an external energy source via a cable connected to the guide carriage. This is disadvantageous because corresponding cable connections frequently are expensive and prone to failure. Alternatively, batteries may be provided for realizing the energy supply of the respective sensors, wherein said batteries are arranged on the guide carriage such that no cable connection to an external energy source is required. This is disadvantageous because the batteries need to be replaced from time to time.

“Energy Harvesting” refers to the process of obtaining energy from external sources and converting said energy into a usable form. In recent years, this concept has become more important in many technical fields, particularly with respect to the creation of sustainable and energy-efficient solutions. There are good reasons for energy harvesting solutions, especially in linear motion devices such as profiled rail guides, ball screws and other mechanical systems that play a significant role in automation technology and precision engineering.

In battery-operated linear motion devices, energy harvesting can contribute to extending the battery service life by using additional energy sources. Many modern applications utilize sensors that are distributed over many locations, e.g. on the movable device components (such as guide carriages) of linear motion devices. These sensors require energy and it is in many instances not feasible to regularly provide these sensors with new batteries. Energy harvesters can remedy this situation. Different technologies for converting and reusing the kinetic or thermal energy generated during the operation of a mechanical device into electrical energy are already in development or use. These include mechanisms such as friction wheels or pressure wheels, piezoelectric substances that produce electricity due to mechanical pressure as a result of vibrations during the operation, as well as thermoelectric generators (TEGs) that obtain electrical energy from temperature differences—e.g. between the guide carriage and its surroundings. In linear motion devices, however, these technologies frequently are not sufficiently effective for generating significant amounts of energy.

### SUMMARY OF THE INVENTION

The present invention therefore is based on the objective of eliminating the disadvantages of the above-described solutions and making available a system for generating electrical energy in a linear motion device, as well as a linear motion device equipped with such a system, which allows efficient, flexibly usable and cost-effective energy harvesting.

The above-defined objective is attained by means of a system for generating electrical energy in a linear motion device with the characteristics of one aspect of the invention and by means of a linear motion device with the characteristics of another aspect of the invention.

The system for generating electrical energy is intended for a linear motion device that has a first device component and a second device component, wherein the second device component is supported on the first device component by means of rolling elements such that the second device component is configured to be moveable linearly relative to the first device component and the rolling elements move relative to the first device component and the second device component when the second device component carries out a movement relative to the first device component during the operation of the linear motion device.

According to the invention, the system for generating electrical energy comprises: the rolling elements that are configured to be moveable along a direction of movement during the operation of the linear motion device; an apparatus for generating a static magnetic field in a spatial region, which the rolling elements have to successively traverse while moving along the direction of movement during the operation of the linear motion device, wherein the rolling elements consist of a magnetically permeable material such that the rolling elements are suitable for influencing the magnetic field in dependence on the position of the rolling elements in the one spatial region; and at least one induction coil with at least one coil winding, wherein the at least one induction coil is arranged stationarily relative to the apparatus for generating a static magnetic field in such a way that, due to a change in the position of the rolling elements during a movement of the rolling elements through the one spatial region along the direction of movement, the induction coil (or the at least one coil winding) experiences a change of a magnetic flux, which induces an electric voltage in the at least one coil winding.

The inventive system for generating electrical energy in a linear motion device provides multiple advantages.

The system directly converts the mechanical energy generated due to the movement of the second device component (e.g. a guide carriage or guide block of a profiled rail guide) along the first device component (e.g. a guide rail of the profiled rail guide) into electrical energy. This makes it possible to efficiently use the existing kinetic energy.

The recovered electrical energy can be used for supplying electrical devices such as sensors, processors or communication interfaces located on the movable device component (e.g. the guide carriage or guide block). In this way, the need for external energy sources can be reduced or even eliminated.

The generated electrical energy can be accumulated and stored in an energy storage such that it is available on demand. This can prolong the service life of battery-operated systems or reduce the need for a regular battery replacement.

The system can be directly integrated into existing linear motion devices such as profiled rail guides or ball screws (recirculating ball screws). No additional moving parts are required such that the reliability and the durability are increased.

The rolling elements themselves do not have to be permanently magnetized elements. The rolling elements merely needs to consist of a magnetically permeable material, which reacts to an external magnetic field made available by the apparatus for generating a static magnetic field in such a way that the respective rolling element influences the generated magnetic field in the surroundings of the rolling element, e.g. with respect to the spatial progression of the field lines or with respect to the field strength of the magnetic field. This results in a magnetic field, which in the surroundings of the rolling elements is dependent on the current position of the respective rolling elements with respect to the direction and/or the magnitude of the field strength. Consequently, a change of the magnetic flux, which due to electromagnetic induction induces an electric voltage in the at least one winding of the induction coil, takes place during a movement of the rolling elements relative to the induction coil (i.e. during a movement of the first device component relative to the second device component).

A relatively high magnetic permeability is achieved due to the use of rolling elements of soft magnetic materials (e.g. steel). This increases the degree of efficiency of the energy conversion because the rolling elements effectively influence the spatial progression of the magnetic field lines.

An electric voltage is periodically induced in the induction coil due to electromagnetic induction during a movement of the second device component (e.g. the guide carriage or guide block) relative to the first device component. This can be useful for applications that require or can use such a periodic energy source.

The attached drawings show multiple embodiments that differ with respect to the construction of the magnetic field generation and the arrangement of the induction coil. This provides developers with a high degree of flexibility in the adaptation to specific applications or construction requirements.

According to a preferred embodiment of the inventive system, it is proposed that the apparatus for generating a static magnetic field is formed by a permanent magnet of hard magnetic material.

The use of a permanent magnet of hard magnetic material in the preferred embodiment has multiple advantages. A permanent magnet of a hard magnetic material ensures a constant and stable magnetic field that is neither affected by external influences nor the arrangement of the rolling elements. Permanent magnets of hard magnetic material have a long service life and only lose their magnetic force very slowly in the course of time. No external energy source is required for the operation of the system because the magnetic field is generated by the permanent magnet.

According to an enhancement of this preferred embodiment, it is proposed that the permanent magnet is essentially realized in a U-shaped manner, wherein its two ends have different magnetic polarities, and wherein the space between these two ends is permeated by magnetic field lines of the static magnetic field and designed for being traversed by the rolling elements during the operation of the linear motion device.

The magnetic field lines concentrate between the two ends of the permanent magnet due to its U-shaped design. A large portion of the magnetic flux of the magnetic field generated by the permanent magnet is concentrated in the rolling elements due to the special arrangement. This ensures optimal use of the magnetic field.

The rolling elements used may be realized in the form of balls, as well as in the form of rollers, wherein these options provide flexibility in the construction. The progression of the magnetic field lines changes depending on the position of the rolling elements and leads to different magnetic field strengths and magnetic field distributions. This property can be used for controlling and modulating the magnetic field. Since the permanent magnet consists of a hard magnetic material, the progression of the field lines in the interior of the magnet is not influenced or only slightly influenced by the position of the rolling elements. This ensures a constant performance of the system.

In an alternative preferred embodiment of the inventive system, the apparatus for generating a static magnetic field is formed by a magnetized element and comprises:
a permanent magnet of hard magnetic material with opposite ends of different magnetic polarity; and
two flux-conducting components, wherein a first end section of a first flux-conducting component is connected to one end of the permanent magnet and a first end section of a second flux-conducting component is connected to an opposite end of the permanent magnet.

This alternative embodiment differs from the preceding embodiment and its enhancement in that flux-conducting components are added. These flux-conducting components, which consist of soft magnetic material with high relative magnetic permeability, play an essential role in the manipulation and the control of the magnetic field generated by the permanent magnet.

The main advantage of this alternative embodiment in comparison with the embodiment with a permanent magnet (without flux-conducting components) can be seen in the improved options for controlling and manipulating the magnetic flux, particularly with respect to the induction coil. The flux-conducting components particularly make it possible to respectively adapt the magnetic field, especially with respect to the spatial progression of the field lines and the field strength, in dependence on the respective arrangement of the permanent magnet, the rolling elements and the induction coil relative to one another by suitably choosing the shape of the respective flux-conducting components and the relative magnetic permeability of the respective material of the flux-conducting components.

Consequently, this alternative embodiment provides improved magnetic field control and maximal induced voltages while simultaneously minimizing potential energy losses (that are caused, in particular, by a generation of eddy currents in a flux-conducting component during a movement of the rolling elements relative to the respective flux-conducting component), particularly in the case of the configuration of the flux-conducting components in the form of a laminated sheet package (i.e. a stacked arrangement of a plurality of thin sheets or foils of soft magnetic material that are electrically insulated from one another), which is suitable for preventing a formation of eddy currents in a flux-conducting component during a movement of the rolling elements. As a result, this alternative embodiment is very efficient and particularly productive.

According to a preferred variation of the above-described embodiment, a pole shoe of soft magnetic material may be arranged on the second end of at least one of the two flux-conducting components, which second end is located adjacent to the at least one induction coil, in order to optimize the spatial progression of the magnetic field lines in the surroundings of the at least one induction coil.

The use of a pole shoe of soft magnetic material makes it possible to optimize the spatial progression of the field lines of the magnetic field in the surroundings of the induction coil. The main objective of this optimization can be seen in maximizing the electrical energy generated during the movement of the movable device component of the linear motion device. This means that a greater portion of the mechanical energy of the movable device component is converted into electrical energy. The shape of the pole shoe and the relative magnetic permeability of the pole shoe material can be appropriately chosen for this optimization. The shape of the pole shoe can be varied in dependence on the shape of the rolling elements and the arrangement of the coil windings of the induction coil.

According to another alternative embodiment of the inventive system, it is proposed that the apparatus for generating a static magnetic field comprises two U-shaped magnetized elements, which respectively consist of a permanent magnet and an L-shaped flux-conducting component and are arranged at a distance from each other and mirror-symmetrically with respect to the direction of movement of the rolling elements, wherein the rolling elements successively traverse the space between the two magnetized elements, which is permeated by magnetic field lines of the static magnetic field, during the operation of the linear motion device.

The magnetic flux density in the space between the two magnetized elements changes with the position of the rolling elements such that the magnetic field strength can be adjusted for certain applications. The changes in position of the rolling elements and the associated changes of the magnetic flux induce an electric voltage in an induction coil and are thereby used for generating and recovering energy.

Since the magnetic field lines extend parallel to the direction of movement of the rolling elements at least in some regions, this alternative embodiment differs from the other embodiments and could be advantageous in certain applications, in which specific interactions between the magnetic field and the rolling elements are required. All in all, this alternative embodiment provides a promising way for generating and controlling magnetic fields for rolling elements, particularly with consideration of a high potential for energy recovery.

According to another alternative embodiment of the inventive system, it is proposed that the apparatus for generating a static magnetic field comprises two magnetized elements that are realized identically and have an E-shaped profile, wherein said magnetized elements are arranged at a distance from each other and mirror-symmetrically with respect to the direction of movement of the rolling elements, wherein the E-shaped profile has three legs and a permanent magnet is arranged on the central leg, and wherein the rolling elements successively traverse the space between the two magnetized elements, which is permeated by magnetic field lines of the static magnetic field, during the operation of the linear motion device.

A uniform and consistent magnetic field is formed in the space between the two magnetized elements with E-shaped profile due to their mirror-symmetrical arrangement. This allows a reliable interaction with the traversing rolling elements. In addition, specific magnetic field configurations can be generated due to the E-shaped profile with three legs. In this context, the central leg with the permanent magnet may serve for generating an intensive and centered magnetic field in the region of the rolling element movement.

A consistent magnetic interaction, which contributes to an efficient generation or recovery of energy, can be ensured because the rolling elements successively traverse the space permeated by magnetic field lines during the operation.

An inventive linear motion device with a first device component and a second device component, in which the second device component is supported on the first device component by means of rolling elements such that the second device component is configured to be moveable linearly relative to the first device component, has at least one inventive system for generating electrical energy, wherein the apparatus for generating a static magnetic field and the at least one induction coil are arranged stationarily to the first device component or stationarily to the second device component.

The advantages of such an inventive linear motion device are obvious.

The linear motion device makes it possible to convert the mechanical energy generated during the movement of the movable device component (e.g. a guide carriage or guide block) into electrical energy. This is referred to as “Energy Harvesting.”

The generated electrical energy can be directly stored in the first or second device component, on which the apparatus for generating a static magnetic field and the at least one induction coil are stationarily arranged. This can contribute to an autonomous energy supply of electrical devices or systems (such as sensors, processors and communication interfaces) arranged on this device component such that the need for external energy sources or frequent battery replacements is reduced or eliminated.

The integration of the inventive system for generating electrical energy into the linear motion device provides a compact and efficient solution that does not require any additional external devices or systems. In addition, the different embodiments of this system disclosed herein provide high flexibility in the integration into different applications or configurations of linear motion devices.

Since the inventive system for generating electrical energy is primarily based on magnetic properties and induction, there are fewer moving parts that can wear out such that the service life is extended and the maintenance requirements for the linear motion device are reduced.

The opportunity to recover and reuse energy can reduce the energy consumption and therefore also the carbon footprint. Energy harvesting can reduce the need for eternal energy sources or regular battery replacements, which in the long term can also lead to cost savings.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIGS. 1 to 4 show a first embodiment of an inventive system for generating electrical energy in a linear motion device in the form of sectional side views (FIGS. 1 and 3) corresponding to a sectional plane extending parallel to the direction of movement of the rolling elements, and in the form of sectional top views (FIGS. 2 and 4) on the sectional planes II-II and IV-IV in FIGS. 1 and 3, which extend perpendicular to the direction of movement of the rolling elements.

FIG. 5 shows a schematic block flowchart of the conversion of mechanical energy into electrical energy, as well as the subsequent storage and use of the electrical energy in an inventive linear motion device.

FIGS. 6 to 9 show a second embodiment of an inventive system for generating electrical energy in a linear motion device in the form of sectional side views (FIGS. 6 and 8) corresponding to a sectional plane extending parallel to the direction of movement of the rolling elements, and in the form of sectional top views (FIGS. 7 and 9) on the sectional planes VII-VII and IX-IX in FIGS. 6 and 8, which extend perpendicular to the direction of movement of the rolling elements.

FIGS. 10 to 13 show a third embodiment of an inventive system for generating electrical energy in a linear motion device in the form of sectional side views (FIGS. 10 and 12) corresponding to a sectional plane extending parallel to the direction of movement of the rolling elements, and in the form of sectional top views (FIGS. 11 and 13) on the sectional planes XI-XI and XIII-XIII in FIGS. 10 and 12, which extend perpendicular to the direction of movement of the rolling elements.

FIGS. 14 and 15 show a fourth embodiment of an inventive system for generating electrical energy in a linear motion device in the form of sectional side views in different movement positions of the rolling elements, said sectional side views corresponding to a sectional plane extending parallel to the direction of movement of the rolling elements.

FIGS. 16 and 17 show a fifth embodiment of an inventive system for generating electrical energy in a linear motion device in the form of sectional side views in different movement positions of the rolling elements, said sectional side views corresponding to a sectional plane extending parallel to the direction of movement of the rolling elements.

FIGS. 18 and 19 show a sixth embodiment of an inventive system for generating electrical energy in a linear motion device in the form of a sectional side view (FIG. 18) corresponding to a sectional plane extending parallel to the direction of movement of the rolling elements, and in the form of a sectional top view (FIG. 19) on the sectional plane XIX-XIX in FIG. 18, which extends perpendicular to the direction of movement of the rolling elements.

### DETAILED DESCRIPTION OF PREFERRED EMBODIMENTS

The attached drawings show different variations of an innovative system for generating electrical energy for linear motion devices such as profiled rail guides or spindle guides/ball screws.

A linear motion device typically comprises a (in many cases stationary) first device component (guide component), e.g. a guide rail in a profiled rail guide or a spindle in a spindle guide or a ball screw. A second device component (guide component), e.g. a guide carriage in a profiled rail guide or a spindle nut in a spindle guide or a ball screw, is guided on the first device component, wherein the second device component moves along the first device component and is supported on the first device component by means of rolling elements such as rollers or balls.

The linear motion device can operate in different modes. In profiled rail guides, particularly in rolling element circulation guides, a continuous rotary or circulatory movement of the balls or rollers takes place along a closed path. These profiled rail guides typically are used in applications, in which the load has to be continuously moved in both directions without requiring a return mechanism.

The system for generating electrical energy proposed herein particularly may be arranged on the movable device component of such linear motion devices. It comprises an apparatus PM, MK1, MK2, MK3 that generates a static magnetic field and delimits a spatial region RB, through which the rolling elements WK (rollers or balls) have to move when the first device component carries out a movement relative to the second device component during the operation of the linear motion device. These rolling elements WK consist of a magnetically permeable material such as a soft magnetic material with high magnetic permeability, i.e. they influence the progression of the magnetic field lines FL of the static magnetic field.

When the second device component moves along the first device component, the magnetic field in the vicinity of the rolling elements WK (rollers or balls) changes in dependence on their current position relative to the respective apparatus PM, MK1, MK2, MK3 for generating the static magnetic field.

In addition to the apparatus PM, MK1, MK2, MK3 for generating the static magnetic field, at least one induction coil IS, IS1, IS2 with at least one winding is respectively provided and arranged in a predefined position (i.e. stationarily) relative to the respective apparatus PM, MK1, MK2, MK3 for generating the static magnetic field. This induction coil IS, IS1, IS2 furthermore is arranged in such a way that changes of the magnetic field, which are caused by a movement of the second device component relative to the first device component, lead to a temporal change of the magnetic flux in the induction coil IS, IS1, IS2. The law of induction states that these changes of the magnetic flux induce an electric voltage U_{ind} in the induction coil IS, IS1, IS2.

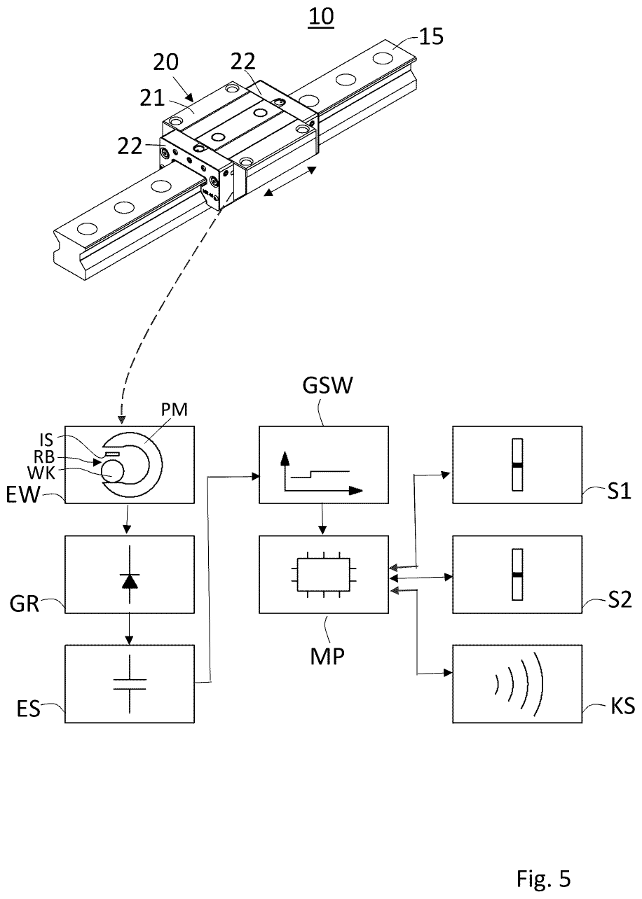

During the movement of the linear motion device, the induction coil IS, IS2, IS3 generates an electric voltage that changes with the temporal change of the magnetic flux. This voltage can be converted into a direct voltage with conventional electronic components and the generated electrical energy can be stored in an energy storage ES (see FIG. 5).

In this process, which is frequently referred to as “Energy Harvesting,” the mechanical energy of the movable device component is converted into electrical energy and stored. This stored electrical energy can be used for operating electrical devices such as sensors S1, S2, processors and communication interfaces KS arranged on the movable device component (see FIG. 5).

The attached drawings show schematic illustrations for visualizing the relevant technical effects. The progressions of the magnetic field lines particularly are illustrated schematically and not exactly calculated.

The invention proposes several embodiments that differ with respect to the construction of the apparatus PM, MK1, MK2, MK3 for generating the static magnetic field, the spatial extent of the magnetic field lines with respect to the direction of movement BR of the rolling elements WK (rollers or balls) and the arrangement of the induction coil(s) IS, IS2, IS3.

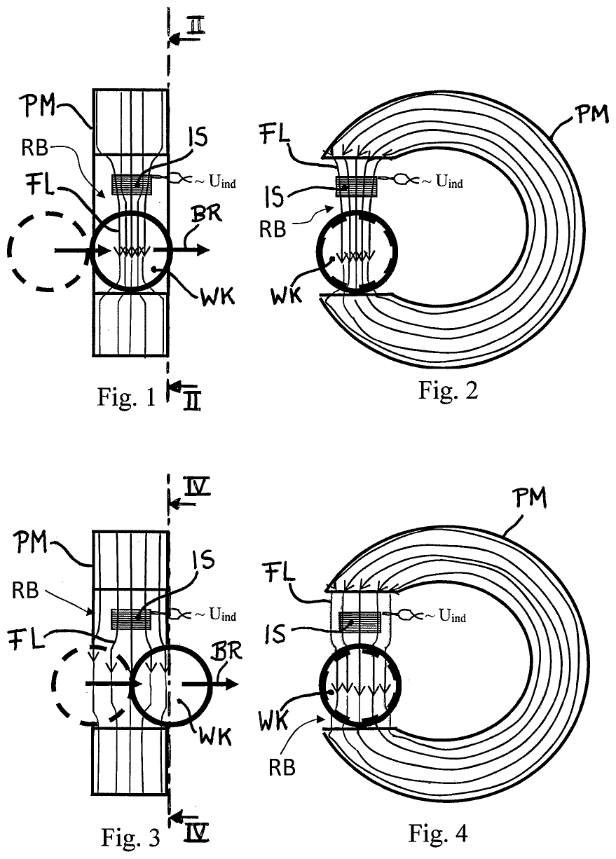

FIGS. 1 to 4 show different views of a first embodiment of an inventive system for generating electrical energy in a linear motion device. These views show different operating states with different arrangements of the rolling elements WK relative to the apparatus PM for generating a static magnetic field.

The rolling elements WK in these figures are realized in the form of balls, but it is also possible to use rolling elements WK in the form of rollers (see FIG. 19).

In this case, the apparatus PM for generating a static magnetic field consists of a single permanent magnet PM that essentially is realized in a U-shaped manner and has different magnetic poles on its two ends.

The magnetic field lines FL extend in the spatial region RB between the ends of the permanent magnet PM in such a way that the total energy of the magnetic field is minimized. As a result, a significant portion of the magnetic flux generated by the permanent magnet PM is concentrated in the rolling elements WK. Each individual rolling element WK has a corresponding magnetization that corresponds to the spatial progression of the magnetic field.

It is important that the arrangement of the rolling elements WK relative to the permanent magnet PM has no influence or only little influence on the progression of the magnetic field lines FL in the permanent magnet PM because this permanent magnet consists of hard magnetic material.

FIGS. 1 to 4 show the magnetic field lines FL in the interior of the rolling elements WK, which essentially extend perpendicular to the direction of movement BR of the rolling elements WK.

In this embodiment, an induction coil IS is arranged in the spatial region RB between the two ends of the permanent magnet PM, which is permeated by the magnetic field lines FL and traversed by the rolling elements WL. To be more precise, this induction coil IS is arranged in a region between one end of the permanent magnet PM and the region, which the rolling elements WK successively traverse during a movement of the movable second device component along the first device component.

The induction coil IS consists of one or more coil windings that respectively extend annularly around a central axis, which essentially is oriented perpendicular to the direction of movement BR of the rolling elements WK. This means that each coil winding of the induction coil IS encloses a surface area that essentially lies parallel to the direction of movement BR of the rolling elements WK.

In the rolling element arrangement illustrated in FIGS. 1 and 2, the magnetic field in the region between the two ends of the permanent magnet PM is concentrated on the volume of a single rolling element WK. Consequently, the magnetic flux assigned to a coil winding of the induction coil IS is relatively high.

In the rolling element arrangement illustrated in FIGS. 3 and 4, the progression of the magnetic field lines FL was modified in such a way that the magnetic field in the spatial region RB between the two ends of the permanent magnet PM is distributed over the volume of two successively arranged rolling elements WK. Consequently, the magnetic flux assigned to a coil winding of the induction coil IS is significantly reduced in comparison with FIGS. 1 and 2.

A change in the position of the rolling elements WK from the arrangement according to FIGS. 1 and 2 to the arrangement according to FIGS. 3 and 4 therefore causes a change of the magnetic flux in the region of the induction coil IS. This change of the magnetic flux induces an electric voltage U_{ind} in the coil windings of the induction coil IS as indicated by the symbol “˜” for alternating voltage at the winding ends of the induction coil IS.

FIG. 5 schematically shows the process of converting mechanical energy into electrical energy taking place in the inventive linear motion device, in this case in the profiled rail guide 10 with a guide carriage 20 and a guide rail 15 illustrated in FIG. 5. In the present example, the guide carriage 20 of the profiled rail guide 10 can be moved linearly in the longitudinal direction of the guide rail 15 and comprises a base body 21 and two end caps 22, which are fastened on the two front surfaces of the base body 21 that lie opposite of one another in the longitudinal direction of the guide rail 15.

In the present example, the guide carriage 20 of the profiled rail guide 10 is supported on the guide rail 15 by means of a plurality of rolling elements WK. In this case, the rolling elements WK are arranged in multiple rolling element circulation channels formed on the guide carriage 20, wherein said circulation channels respectively extend along a closed annular curve and accordingly allow a circulation of the rolling elements WK along closed annular circulation paths during a movement of the guide carriage 20 in the longitudinal direction of the guide rail 15, wherein two sections of each of these closed annular circulation paths respectively extend on the base body 21 or through the base body 21 in the longitudinal direction of the guide rail 15 and two other sections of each of these closed annular paths respectively extend through the two end caps 22 (the spatial progression of these closed circulation paths of the rolling elements WK is not illustrated in FIG. 5).

In the example according to FIG. 5, the process of converting mechanical energy into electrical energy comprises multiple key components:

Mechanical energy initially is generated in the linear motion device, i.e. in the profiled rail guide 10 in the example according to FIG. 5. For this purpose, the guide carriage 20 is moved in the longitudinal direction of the guide rail 15 (as indicated by a double arrow positioned in the vicinity of the guide carriage 20 in FIG. 5). This energy is then transferred to an “energy converter” EW, which corresponds to the inventive system for generating electrical energy. The centerpiece of this energy converter EW is the arrangement of an apparatus for generating a static magnetic field, i.e. in the present example a permanent magnet PM illustrated in FIGS. 1-4, in combination with an induction coil IS illustrated in FIGS. 1-4, in which a voltage U_{ind} is induced during a movement of the guide carriage 20 in the longitudinal direction of the guide rail 15. The generation of this voltage U_{ind} is based on the principle that electrical energy is generated when rolling elements WK of the profiled rail guide 10 are moved relative to the apparatus PM for generating a static magnetic field and in the process cause a change of the magnetic flux in the induction coil IS.

This induced voltage U_{ind} initially has to be rectified in order to make it usable for electronic devices. This is realized with the aid of a rectifier GR that converts the alternating voltage into a direct voltage. The thusly generated direct voltage is subsequently stored in an energy storage ES. Different components such as a capacitor or an accumulator can serve as energy storage ES.

The stored energy ultimately is used for supplying different electronic components, e.g. a “DC/DC converter” GSW and a microprocessor MP that can be supplied with energy by the DC/DC converter GSW. This special system in FIG. 5 comprises components such as the sensor S1 and the sensor S2, which can be used for acquiring certain data. A wireless communication interface KS is also provided. This communication interface can be used for the wireless transmission of the data acquired by the sensors S1, S2 to other systems or devices. The sensors S1, S2 and the wireless communication interface KS may be connected to the microprocessor MP as indicated in FIG. 5 in order to allow the transmission of data.

In the example according to FIG. 5, the energy converter EW consisting of the apparatus PM for generating a static magnetic field and the induction coil IS may be arranged on the guide carriage 20, e.g. stationarily, such that the energy converter EW is moved together with the guide carriage 20 during a movement of the guide carriage 20 along the guide rail 15. In this case, the energy converter EW may be installed in the vicinity of a circulation path of the rolling elements WK, e.g. on the base body 21 or in a recess formed in the base body 21 or on one of the end caps 22 or in a recess formed in one of the end caps 22 (not illustrated in FIG. 5). Accordingly, the remaining electronic components illustrated in FIG. 5 (rectifier GR, energy storage ES, DC/DC converter GSW, microprocessor MP, sensor S1, sensor S2, wireless communication interface KS) may be respectively arranged on the guide carriage 20 stationarily or integrated into the guide carriage 20.

The energy converter EW may form a compact unit together with one or more of the aforementioned electronic components (e.g. the rectifier GR, the energy storage ES, one or more sensors S1 and/or S2), wherein said compact unit may be implemented, for example, on a single carrier or in a single housing. Such a unit may be advantageously installed as a whole in the vicinity of a circulation path of the rolling elements WK, e.g. on the base body 21 or in a recess formed in the base body 21 or on one of the end caps 22 or in a recess formed in one of the end caps 22 (not illustrated in FIG. 5).

All in all, FIG. 5 provides a clear overview of the energy conversion and utilization process in a concrete technical system according to the present invention, which is based on the objective of efficiently converting mechanical energy in a linear motion device into electrical energy and making this electrical energy usable for different electronic applications.

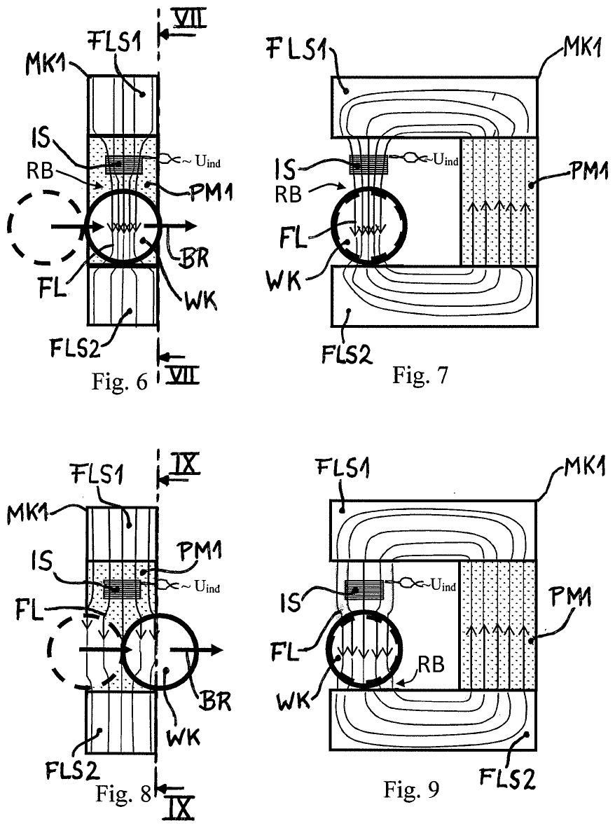

FIGS. 6 to 9 show different views of a second embodiment of an inventive system for generating electrical energy in a linear motion device. These views resemble those in FIGS. 1 to 4 and show different perspectives and arrangements of the rolling elements WK in relation to the apparatus MK1 for generating a static magnetic field.

The second embodiment essentially differs from the first embodiment in that the permanent magnet PM is replaced with a magnetized element. This magnetized element is identified by the reference symbol MK1 and consists of a permanent magnet PM1 and two flux-conducting components FLS1 and FLS2. The permanent magnet PM1 is a homogenously magnetized cuboid of hard magnetic material, which has different magnetic poles on its opposite ends. The two flux-conducting components FLS1 and FLS2 consist of soft magnetic material with high relative magnetic permeability and high saturation magnetization and are magnetized by the magnetic field generated by the permanent magnet PM1.

In this second embodiment, the rolling elements WK (in this case balls) are arranged in such a way that they have to traverse a spatial region RB between the two ends of the flux-conducting components FLS1 and FLS2 during a movement of the movable device component (e.g. the guide carriage or guide block) along the stationary device component (e.g. the guide rail). The arrangement of the permanent magnet PM1, the flux-conducting components FLS1 and FLS2 and the rolling elements WK causes the magnetic field lines FL to extend along closed, essentially annular curves in the region of these components.

FIGS. 6 and 8 show the second embodiment from the same perspective, namely in a view perpendicular to the direction of movement BR of the rolling elements WK. However, FIG. 8 shows an operating state, in which the rolling elements WK are, in comparison with the operating state according to FIG. 6, offset in the direction of movement BR by a distance that approximately corresponds to the radius of a rolling element WK.

FIG. 7 shows the same rolling element arrangement as FIG. 6, but in the form of a top view on the plane VII-VII in FIG. 6 extending perpendicular to the direction of movement BR. FIG. 9 shows the same rolling element arrangement as FIG. 8, but likewise in the form of a top view on the plane IX-IX in FIG. 8 extending perpendicular to the direction of movement BR.

In the embodiment according to FIGS. 6 to 9, the magnetic field lines FL in the interior of the rolling elements WK also extend essentially perpendicular to the direction of movement BR of the rolling elements WK.

An induction coil IS is also arranged in a spatial region RB between the free end of one flux-conducting component FLS1 and the free end of the other flux-conducting component FLS2 in this second embodiment. To be more precise, the induction coil IS is located in a region between one end of the flux-conducting component FLS1 and a region in the space between the ends of the two flux-conducting components FLS1 and FLS2, which the rolling elements WK successively traverse when the movable device component is moved along the stationary device component. The induction coil IS resembles that of the first embodiment and consists of one or more coil windings that extend annularly around a central axis of the induction coil IS, which essentially is oriented perpendicular to the direction of movement BR of the rolling elements WK.

In the operating state illustrated in FIGS. 6 and 7, the arrangement of the rolling elements is realized in such a way that the static magnetic field generated in the region between the second end of one flux-conducting component FLS1 (which faces away from the permanent magnet PM1) and the second end of the other flux-conducting component FLS2 (which faces away from the permanent magnet PM1) is concentrated on the volume of a single rolling element WK. As a result, the magnetic flux assigned to a coil winding of the induction coil IS is relatively high.

In the rolling element arrangement according to the operating state in FIGS. 8 and 9, the progression of the magnetic field lines FL is modified in such a way that the static magnetic field generated in the region between the second end of the one flux-conducting component FLS1 (which faces away from the permanent magnet PM1) and the second end of the other flux-conducting component FLS2 (which faces away from the permanent magnet PM1) is distributed over the volume of two successively arranged rolling elements WK. As a result, the magnetic flux assigned to a coil winding of the induction coil IS is significantly reduced in comparison with the operating state illustrated in FIGS. 6 and 7.

The change in position of the rolling elements WK from the arrangement according to FIGS. 6 and 7 to the arrangement according to FIGS. 8 and 9 and vice versa causes a change of the magnetic flux in the region of the induction coil IS. This change induces an electric voltage in the windings of the induction coil IS, wherein said electric voltage is indicated by the symbol “˜” for alternating voltage on the winding ends of the induction coil IS.

In summary, the second embodiment according to FIGS. 6 to 9 primarily differs from the first embodiment in that flux-conducting components FLS1 and FLS2 are added. These flux-conducting components FLS1 and FLS2 allow a greater change of the magnetic flux and therefore a higher induced voltage U_{ind} during the transition of the rolling elements WK between the two arrangements. In order to minimize the energy losses, which could be caused by the generation of eddy currents in one of the flux-conducting components FLS1 and FLS2 during a movement of the rolling elements relative to the respective flux-conducting component FLS1 or FLS2, the flux-conducting components FLS1 and FLS2 can be advantageously realized in the form of laminated sheet packages of soft magnetic material.

Advantageous soft magnetic materials for the flux-conducting components FLS1 and FLS2 particularly are materials that have a high relative magnetic permeability, a low coercive field strength and a high saturation magnetization (such as, for example, NiFe, SiFe or CoFe alloys).

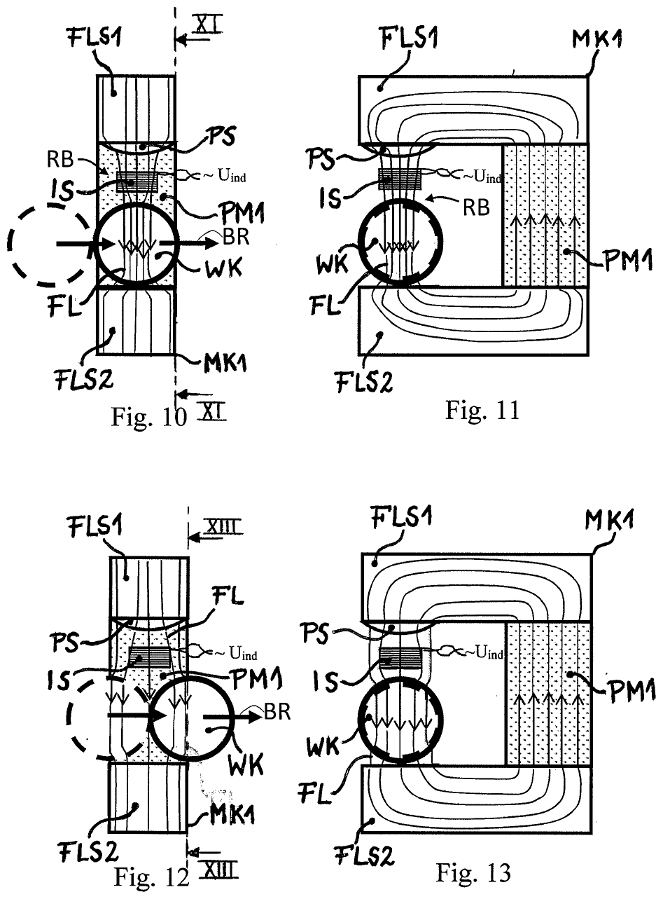

FIGS. 10 to 13 show different views of a third embodiment of an inventive system for generating electrical energy in a linear motion device. This embodiment essentially resembles the second embodiment illustrated in FIGS. 6 to 9. However, one distinctive difference can be seen in that a so-called pole shoe PS of a soft magnetic material is formed on the second end of one of the two flux-conducting components FLS1 located near the induction coil IS (which second end faces away from the permanent magnet PM1).

The pole shoe PS makes it possible to purposefully modify and control the magnetic field in the vicinity of the induction coil IS. The main objective of this modification and control is the increase of the electrical energy generated due to the movement of the movable device component of the linear motion device. In other words, the degree of efficiency of the conversion of the mechanical energy of the movable device component into electrical energy should be maximized.

The shape of the pole shoe PS and the magnetic permeability of the pole shoe material used should be carefully chosen in order to attain this objective. The geometry of the pole shoe PS particularly can be configured in dependence on the geometry of the rolling elements WK (e.g. balls or rollers) and the arrangement of the coil windings of the induction coil IS.

In order to ensure maximum energy conversion of the mechanical energy of the linear motion device into the generated electrical energy, the magnetic field around the induction coil IS needs to be optimized by means of the pole shoe PS in such a way that the magnetic flux assigned to a coil winding of the induction coil IS is on the one hand maximal in the arrangement illustrated in FIGS. 10 and 11 and this magnetic flux is on the other hand minimal in the arrangement of the rolling elements WK illustrated in FIGS. 12 and 13.

The special design of the third embodiment according to FIGS. 10 to 13 allows this optimization. The pole shoe PS has a convexly curved surface, i.e. an outwardly curved surface, on its side facing the induction coil IS. In addition, this pole shoe PS is arranged symmetrically to an extension of the central axis of the induction coil IS. This central axis is defined as a line that extends perpendicularly through the center of the surface defined by a coil winding of the induction coil IS.

Due to this special design of the pole shoe PS, the magnetic flux in the rolling elements WK is controlled in such a way that it is particularly low in the rolling element arrangement according to FIGS. 12 and 13, wherein this can also be attributed to the convexly curved surface of the pole shoe PS.

The result of this optimization is a significant change of the magnetic flux during a movement of the rolling elements WK between the positions illustrated in FIGS. 10 and 11 on the one hand and in FIGS. 12 and 13 on the other hand. This leads to a high induced voltage U_{ind}.

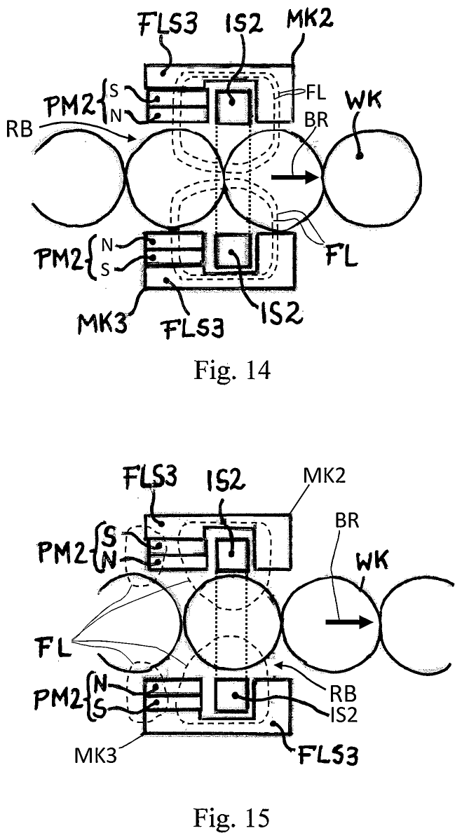

FIGS. 14 and 15 show a fourth embodiment of an inventive system for generating electrical energy in a linear motion device, wherein these figures show two different arrangements of the rolling elements WK with respect to the apparatus MK2, MK3 for generating a static magnetic field in the form of sectional side views corresponding to a sectional plane extending parallel to the direction of movement BR of the rolling elements WK.

The apparatus for generating a magnetic field used in this embodiment consists of two identical and essentially U-shaped magnetized elements MK2 and MK3. Each of these magnetized elements MK2 and MK3 consists of a permanent magnet PM2 and an L-shaped flux-conducting component FLS3 of soft magnetic material. The flux-conducting component FLS3 is connected to an end face of the permanent magnet PM2 on one end section and therefore magnetized by the permanent magnet PM2. An opposite end section of the flux-conducting component FLS3 forms the second leg of the U-shaped magnetized element MK2 and MK3.

The two magnetized elements MK2 and MK3 are arranged at a distance from one another on opposite sides of the spatial region RB, which the rolling elements WK successively traverse in the direction of movement BR when the movable device component (e.g. guide carriage or guide block) is moved in the longitudinal direction of the other device component (e.g. guide rail). The magnetized elements MK2 and MK3 are arranged at a distance from each other and in a mirror-inverted manner with respect to the direction of movement BR of the rolling elements WK as illustrated in FIGS. 14 and 15. In this case, the rolling elements WK are realized in the form of rollers and FIGS. 14 and 15 respectively show a side view parallel to the longitudinal axis of these rollers.

The two magnetized elements MK2 and MK3 extend in the direction of movement BR of the rolling elements WK and have an extent that approximately corresponds to the diameter of the rolling elements WK referred to the direction of movement BR.

FIG. 14 shows an operating state, in which the rolling elements WK are arranged in the direction of movement BR in such a way that one of two successively arranged rolling elements WK lies in an intermediate space between the permanent magnets PM2 of the magnetic elements MK2 and MK3. The other of the two successively arranged rolling elements WK is at the same time located in an intermediate space between an end of the second leg of the magnetized element MK2, which is formed by the flux-conducting component FLS3, and an end of the second leg of the magnetized element MK3, which is likewise formed by the flux-conducting component FLS3.

In comparison with the arrangement in the operating state according to FIG. 14, the rolling elements WK in the operating state according to FIG. 15 are offset in the direction of movement BR by approximately half the rolling element diameter.

In any case, the two magnetized elements MK2 and MK3 are arranged at a distance from each other and mirror-symmetrically with respect to the direction of movement BR of the rolling elements WK and their permanent magnets PM2 are aligned in such a way that the magnetizations of the permanent magnets PM2 of both magnetized elements MK2 and MK3 are oriented perpendicular to the direction of movement BR of the rolling elements WK. In this case, the magnetizations of the permanent magnet PM2 of the one magnetized element MK2 and of the permanent magnet PM2 of the other magnetized element MK3 are oriented oppositely, wherein the polarities in FIGS. 14 to 19 are respectively identified by “S” for “south pole” and “N” for “north pole.”

The two magnetized elements MK2 and MK3 therefore generate a magnetic field, the field lines FL of which (represented by broken lines in FIGS. 13 and 14) extend in contrast to the preceding embodiments according to FIGS. 1 to 13 at least partially parallel to the direction of movement BR of the rolling elements WK, in the spatial region BR that the rolling elements WK have to successively traverse during a movement of a movable device component of the linear motion device in the longitudinal direction of the other device component of the linear motion device.

In the rolling element arrangement according to FIG. 14, the rolling elements WK between the magnetized elements MK2 and MK3 are magnetized relatively strong because they are located exactly in an intermediate space between the permanent magnets PM2 and between the free legs of the magnetized flux-conducting components FLS1 and FLS2. This leads to a relatively high magnetic flux density in the space between the two magnetized elements MK2 and MK3 as illustrated in FIG. 14.

In the operating state according to FIG. 15, the rolling elements WK are on the other hand arranged in such a way that the permanent magnets PM2 of the magnetized elements MK2 and MK3, as well as the free legs of the flux-conducting components FLS1 and FLS2 of the magnetized elements MK2 and MK3, are in an “intermediate position” between two successively arranged rolling elements WK. In this arrangement, the magnetic field, which is generated by the permanent magnets PM2 and transmitted by the flux-conducting components FLS1 and FLS2, essentially is distributed over two successively arranged rolling elements WK and their surroundings.

Consequently, the two magnetized elements MK2 and MK3 generate a magnetic field, the field lines FL of which extend at least partially parallel to the direction of movement BR of the rolling elements WK, in both rolling element arrangements.

The broken lines in FIGS. 14 and 15 indicate that the change in position of the rolling elements WK during the transition from the arrangement according to FIG. 14 to the arrangement according to FIG. 15 causes a change of the spatial progression of the field lines FL with respect to the arrangement of the magnetized elements MK2 and MK3 and the induction coil IS2 and therefore a change of the magnetic flux. This leads to the induction of an electric voltage U_{ind} in an induction coil IS2, the central axis of which extends collinearly to the direction of movement BR of the rolling elements WK. The coil windings of the induction coil IS2 therefore extend annularly around the spatial region RB, which the rolling elements WK have to successively traverse, as illustrated in FIGS. 14 and 15. The coil windings of the induction coil IS2 are respectively arranged in a space-saving manner between the two legs of the U-shaped magnetized elements MK2 and MK3 (i.e. respectively arranged between the leg formed by the permanent magnet PM2 and the leg formed by the flux-conducting component FLS2, FLS3).

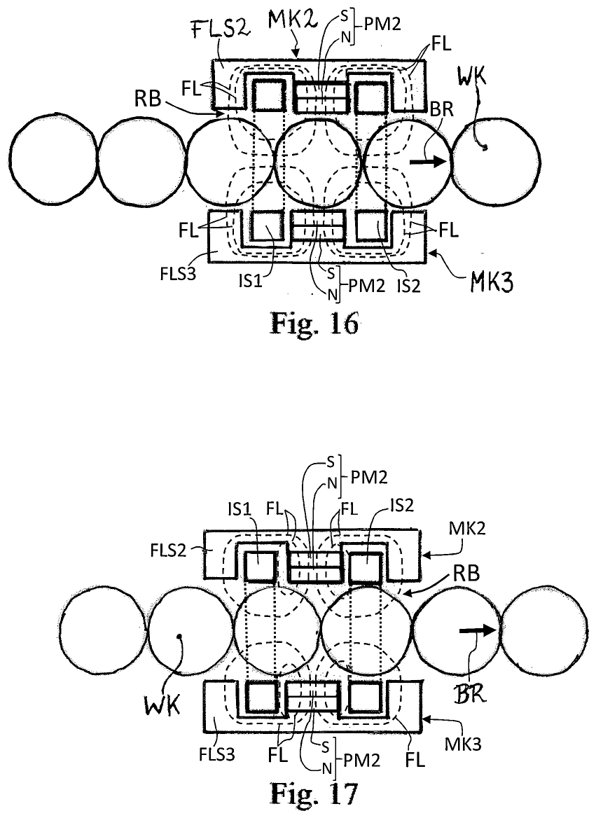

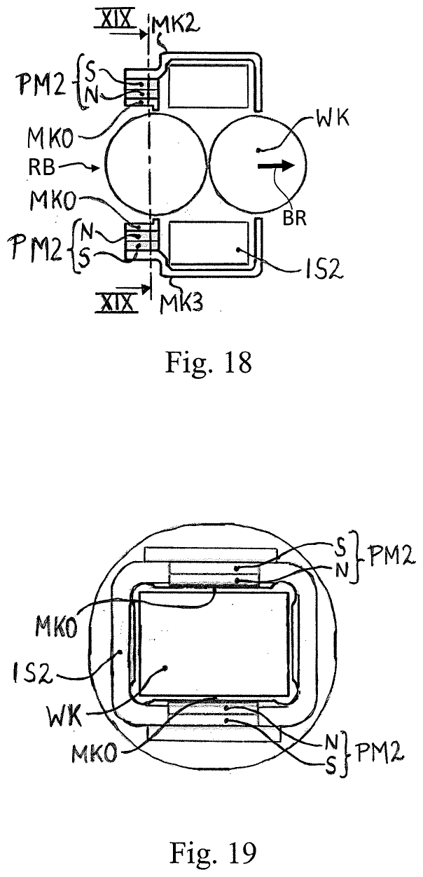

FIGS. 16 to 19 show detailed illustrations of two additional variations of an inventive system for generating electrical energy in a linear motion device, which are based on the preceding fourth embodiment according to FIGS. 14 and 15. These additional variations are referred to as fifth embodiment (FIGS. 16 and 17) and sixth embodiment (FIGS. 18 and 19) herein.

In the fifth embodiment according to FIGS. 16 and 17, an additional constructive modification of the apparatus MK2, MK3 for generating the static magnetic field is realized. In the embodiment according to FIGS. 14 and 15, two magnetized elements MK2 and MK3 consisting of an L-shaped flux-conducting component FLS3 and a permanent magnet PM2 are used whereas the design of these magnetized elements MK2 and MK3 is modified in the fifth embodiment according to FIGS. 16 and 17. These figures respectively show two identically designed magnetized elements MK2 and MK3 in the form of a sectional side view corresponding to a sectional plane extending parallel to the direction of movement BR of the rolling elements WK, wherein the magnetized elements MK2 and MK3 respectively have an E-shaped profile with a total of three legs that are spaced apart in the direction of movement BR. The central leg of these E-shaped magnetized elements MK2 and MK3 is formed by a permanent magnet PM2 on a side that faces the spatial region RB traversed by the rolling elements WK. The remaining part of the magnetized elements MK2 and MK3 is respectively formed by a flux-conducting component FLS2, FLS3 with an E-shaped profile, wherein the length of the central leg of the flux-conducting components FLS2, FLS3 is respectively shortened in a direction extending perpendicular to the direction of movement BR by a length that corresponds to the length of the attached permanent magnet PM2.

Another significant difference of this fifth embodiment in comparison with FIGS. 14 and 15 is the arrangement and the number of induction coils. Two separate induction coils IS1 and IS2 are used in this fifth embodiment instead of the single induction coil IS2 illustrated in FIGS. 14 and 15. These two induction coils IS1 and IS2 are arranged behind one another viewed in the direction of movement BR of the rolling elements WK and spaced apart from one another in such a way that they are located on opposite sides of the permanent magnet PM2 attached to the central leg.

The field lines FL of the magnetic field generated by the magnetized elements MK2 and MK3 are illustrated with broken lines in FIGS. 16 and 17. In the region of the induction coil IS1, the generated magnetic field obviously is oriented essentially parallel to the longitudinal axis of the induction coil IS1 (or perpendicular to the surface delimited by a coil winding of the induction coil IS1). Accordingly, the generated magnetic field is in the region of the induction coil IS2 essentially oriented parallel to the longitudinal axis of the induction coil IS2 (or perpendicular to the surface delimited by a coil winding of the induction coil IS2).

The change in position of the rolling elements WK during the transition from the arrangement according to FIG. 16 to the arrangement according to FIG. 17 causes a change of the spatial progression of the field lines FL with respect to the arrangement of the magnetized elements MK2 and MK3 and the induction coils IS1 and IS2 and therefore a change of the magnetic flux in the region of the induction coil IS1, as well as in the region of the induction coil IS2, such that an electric voltage is respectively induced in the respective coil windings of the induction coil IS1, as well as in the respective coil windings of the induction coil IS2, due to the changes of the magnetic flux in the region of the induction coil IS1 and in the region of the induction coil IS2.

Significant modifications in the construction of the magnetized elements MK2 and MK3 and also in the arrangement and the number of induction coils IS1 and IS2 were carried out in the fifth embodiment. These modifications aim to optimize the functionality of the system. The special characteristic of these modifications is the bilateral arrangement of the induction coils IS1 and IS2 around the central permanent magnet PM2. This allows the detection of different polarities in the static magnetic field being influenced by the rolling elements WK. This can lead to a more accurate and more differentiated measurement in that the effect of the rolling elements WK on the magnetic field is determined from different directions. The fifth embodiment therefore aims to improve the sensitivity and the precision of the system with respect to the interaction between the rolling elements WK and the magnetic field.

The sixth embodiment according to FIGS. 18 and 19 also is constructively based on the fourth embodiment according to FIGS. 14 and 15. However, an additional measure for achieving a further performance enhancement has been taken in this case. A magnetic field concentrator MKO of a soft magnetic material with high relative magnetic permeability is respectively arranged on the permanent magnets PM2 of the magnetized elements MK2 and MK3 on the side facing the space traversed by the rolling elements WK. This magnetic field concentrator MKO has the function of concentrating the magnetic field on the smallest space possible in the vicinity of the respective rolling element WK.

This modification can be used for increasing the magnetic field strength in the immediate vicinity of the respective rolling element WK, which in turn can improve the degree of efficiency of the energy generation. A stronger magnetic field in the vicinity of the respective rolling element WK can lead to a greater change of the magnetic flux during a movement of this rolling element WK. This in turn would lead to a higher induced voltage U_{ind} in the induction coil IS2 and therefore an improved degree of efficiency of the energy generation.

Consequently, the sixth embodiment aims to improve the performance of the system by using magnetic field concentrators MKO. These magnetic field concentrators MKO should focus the magnetic field closer to the rolling elements WK in order to allow an improved detection of the changes in the magnetic flux.

The proposed system particularly can be used as an innovative approach for operating and monitoring guide carriages in profiled rail guides. Potential challenges with respect to power supply and wiring can be avoided due to the direct integration of the proposed system (“energy harvester”) into the guide carriage.

The main advantage of this system can be seen in that it enables the guide carriage to operate in an autarkic manner. The generated energy is used for operating a sensor system—that acquires important data such as the quantity and/or state of a lubricant for lubricating the rolling elements, the humidity and/or the temperature in the surroundings of the rolling elements—and a wireless data transmission device. This eliminates the need for an external power supply, which can be very advantageous in many industrial applications, particularly in areas in which wiring is problematic or expensive.

A significant advantage of the proposed system can be seen in that it provides the option of an autarkic energy supply for a wireless data transmission. Although WLAN and Bluetooth are established protocols, it is important to ensure the reliability and safety of these connections at all times in industrial environments, in which malfunctions or other challenges can potentially arise.

The use of rectifiers GR and energy storages ES ensures that the generated energy is efficiently used and stored. This ensures that the sensor system and the data transmission device are continuously supplied with the required energy.

In conclusion, the combination of the energy generating system proposed herein, the sensor technology and the wireless data transmission in a linear motion device (such as a profiled rail guide or ball screw) has the potential to revolutionize the manner, in which linear motion devices are used and monitored. It not only provides an autarkic energy source, but also allows improved monitoring and data transmission, which can contribute to optimizing the operation and to the early detection of problems.

Although only a few embodiments of the present invention have been shown and described, it is to be understood that many changes and modifications may be made thereunto without departing from the spirit and scope of the invention.

What is claimed is:

1. A system for generating electrical energy in a linear motion device (10) that has a first device component (15) and a second device component (20), wherein the second device component (20) is supported on the first device component (10) by means of rolling elements (WK) such that the second device component (20) is configured to be moveable linearly relative to the first device component (15) and the rolling elements (WK) move relative to the first device component and the second device component when the second device component carries out a movement relative to the first device component during the operation of the linear motion device (10), wherein the system for generating electrical energy comprises:
the rolling elements (WK) that are configured to be moveable along a direction of movement (BR) during the operation of the linear motion device;
an apparatus (PM, MK1, MK2, MK3) for generating a static magnetic field in a spatial region (RB), which the rolling elements (WK) have to successively traverse while moving along the direction of movement (BR) during the operation of the linear motion device, wherein the rolling elements (WK) comprise a magnetically permeable material such that the rolling elements (WK) are suitable for influencing the magnetic field in dependence on the position of the rolling elements (WK) in the one spatial region (RB); and
at least one induction coil (IS, IS1, IS2) with at least one coil winding, wherein the at least one induction coil (IS, IS1, IS2) is arranged stationarily relative to the apparatus (PM, MK1, MK2, MK3) for generating a static magnetic field in such a way that, due to a change in the position of the rolling elements (WK) during a movement of the rolling elements (WK) through the one spatial region (RB) along the direction of movement (BR), the induction coil experiences a change of a magnetic flux, which induces an electric voltage (U_{ind}) in the at least one coil winding.

2. The system according to claim 1, wherein the rolling elements (WK) move along a closed path in a circulating manner or wherein the rolling elements (WK) move along a fixed path and return to their starting position on one end.

3. The system according to claim 1, wherein the rolling elements (WK) are realized in the form of balls or rollers.

4. The system according to claim 1, wherein the apparatus (PM, MK1, MK2, MK3) for generating a static magnetic field is formed by a permanent magnet (PM) of hard magnetic material.

5. The system according to claim 4, wherein the permanent magnet (PM) essentially is realized in a U-shaped manner, wherein its two ends have different magnetic polarities, and wherein the space between these two ends is permeated by magnetic field lines (FL) of the static magnetic field and designed for being traversed by the rolling elements (WK) during the operation of the linear motion device (10).

6. The system according to claim 1, wherein the apparatus for generating a static magnetic field is formed by a magnetized element (MK1) comprising:
a permanent magnet (PM1) of hard magnetic material with opposite ends of different magnetic polarity; and
two flux-conducting components (FLS1, FLS2), wherein a first end section of a first flux-conducting component (FLS1) is connected to one end of the permanent magnet (PM1) and a first end section of a second flux-conducting component (FLS2) is connected to an opposite end of the permanent magnet (PM1).

7. The system according to claim 6, wherein the two flux-conducting components (FLS1, FLS2) comprise a soft magnetic material with high relative magnetic permeability.

8. The system according to claim 6, wherein the magnetized element (MK1) essentially is realized in a U-shaped manner, and wherein the space between the second end of the one flux-conducting component (FLS1) and the second end of the other flux-conducting component (FLS2) is permeated by magnetic field lines (FL) of the static magnetic field and designed for being traversed by the rolling elements (WK) during the operation of the linear motion device.

9. The system according to claim 8, wherein the magnetic field lines (FL) extend along closed, essentially annular curves in the region of the permanent magnet (PM1), the two flux-conducting components (FLS1, FLS2) and the rolling elements (WK).

10. The system according to claim 8, wherein the flux-conducting components (FLS1, FLS2) are designed and arranged in such a way that the spatial progression of the magnetic field lines (FL) changes with the respective position of the rolling elements (WK) relative to the flux-conducting components (FLS1, FLS2).

11. The system according to claim 8, wherein a pole shoe (PS) of soft magnetic material is arranged on the second end of at least one of the two flux-conducting components (FLS1, FLS2), which second end is located adjacent to the at least one induction coil (IS), in order to optimize the spatial progression of the magnetic field lines (FL) in the surroundings of the at least one induction coil (IS).

12. The system according to claim 11, wherein a pole shoe geometry and a relative magnetic permeability of the pole shoe material are optimized for ensuring a maximum energy conversion from the mechanical energy of the linear motion device into the generated electrical energy.

13. The system according to claim 11, wherein the pole shoe geometry is realized in dependence on the geometry of the rolling elements (WK) and the arrangement of the at least one winding of the induction coil (IS).

14. The system according to claim 11, wherein the pole shoe (PS) has a convexly curved surface on the side facing the at least one induction coil (IS).

15. The system according to claim 11, wherein the pole shoe (PS) is realized symmetrically to a central axis of the induction coil (IS).

16. The system according to claim 5, wherein the magnetic field lines (FL) essentially extend perpendicular to the direction of movement (BR) of the rolling elements (WK).

17. The system according to claim 1, wherein the at least one induction coil (IS) is arranged in or on the spatial region (RB), which the rolling elements (WK) successively traverse while they move along the direction of movement (BR) during the operation of the linear motion device.

18. The system according to claim 1, wherein the at least one induction coil (IS) has one or more coil windings that extend annularly around a central axis of the induction coil (IS).

19. The system according to claim 18, wherein the one or more coil windings of the at least one induction coil (IS) respectively enclose a surface area that is essentially aligned parallel to the direction of movement (BR) of the rolling elements (WK).

20. The system according to claim 1, wherein the apparatus for generating a static magnetic field comprises two U-shaped magnetized elements (MK2, MK3), which respectively comprise a permanent magnet (PM2) and an L-shaped flux-conducting component (FLS3) and are arranged at a distance from each other and mirror-symmetrically with respect to the direction of movement (BR) of the rolling elements (WK), and wherein the rolling elements (WK) successively traverse the spatial region (RB) between the two magnetized elements (MK2, MK3), which is permeated by the magnetic field lines (FL) of the static magnetic field, during the operation of the linear motion device.

21. The system according to claim 20, wherein the extent of the magnetized elements (MK2, MK3) in the direction of movement (BR) approximately corresponds to the diameter of the rolling elements (WK).

22. The system according to claim 20, wherein a rolling element (WK), which follows or precedes a rolling element (WK) positioned between the permanent magnets (PM2) of the two magnetized elements (MK2, MK3), is arranged between the ends of the flux-conducting components (FLS3) of the two magnetized elements (MK2, MK3).

23. The system according to claim 20, wherein the at least one induction coil (IS2) is arranged in such a way that the at least one coil winding of the at least one induction coil (IS2) extends annularly around the spatial region (RB), which the rolling elements (WK) successively traverse.

24. The system according to claim 23, wherein the at least one induction coil (IS2) is arranged in such a way that the at least one coil winding of the at least one induction coil (IS2) respectively extends through an intermediate space between the permanent magnet (PM2) and the flux-conducting component (FLS3) of the one magnetized element (MK2) and through an intermediate space between the permanent magnet (PM2) and the flux-conducting component (FLS3) of the other magnetized element (MK3).

25. The system according to claim 1, wherein the apparatus for generating a static magnetic field comprises two identically designed magnetized elements (MK2, MK3) with an E-shaped profile, which are arranged at a distance from each other and mirror-symmetrically with respect to the direction of movement (BR) of the rolling elements (WK), wherein the E-shaped profile has three legs and a permanent magnet (PM2) is arranged on the central leg, and wherein the rolling elements (WK) successively traverse the spatial region (RB) between the two magnetized elements (MK2, MK3), which is permeated by magnetic field lines (FL) of the static magnetic field, during the operation of the linear motion device.

26. The system according to claim 25, wherein two induction coils (IS1, IS2) are arranged behind one another viewed in the direction of movement (BR) of the rolling elements (WK) and on opposite sides of the permanent magnet (PM2), and wherein the at least one coil winding of the two induction coils respectively extends annularly around the spatial region (RB), which the rolling elements (WK) successively traverse.

27. The system according to claim 26, wherein the two induction coils (IS1, IS2) are arranged in such a way that they respectively detect a different polarity of the static magnetic field influenced by the rolling elements (WK).

28. The system according to claim 20, wherein the magnetic field lines (FL) partially extend parallel to the direction of movement (BR) of the rolling elements (WK).

29. The system according to claim 20, wherein a magnetic field concentrator (MKO) of soft magnetic material with high relative magnetic permeability is arranged on the permanent magnet (PM2) of the one magnetized element (MK2) and/or on the permanent magnet (PM2) of the other magnetized element (MK3) in order to concentrate the magnetic field on the smallest space possible in the vicinity of a rolling element (WK).

30. The system according to claim 1, furthermore comprising a rectifier (GR) for converting the voltage (U_{ind}) induced in the at least one induction coil (IS) into a direct voltage.

31. The system according to claim 1, furthermore comprising an energy storage (ES) for the storage and further use of the generated electrical energy, wherein said energy storage is selected from the group comprising: capacitor and accumulator.

32. The system according to claim 1, which is designed for supplying electrical components on the first device component (15) or the second device component (20) of the linear motion device (10) with the generated electrical energy.

33. The system according to claim 32, wherein the electrical components comprise at least one sensor (S1, S2).

34. The system according to claim 32, wherein the electrical components comprise at least one wireless communication interface (KS) for transmitting data.

35. A linear motion device (10) with a first device component (15) and a second device component (20), wherein the second device component (20) is supported on the first device component (15) by means of rolling elements (WK) such that the second device component (20) is configured to be moveable linearly relative to the first device component (15), wherein said linear motion device comprises at least one system according to claim 1, and wherein the apparatus for generating a static magnetic field and the at least one induction coil are arranged stationarily to the first device component or stationarily to the second device component.

36. The linear motion device according to claim 35, which is realized in the form of a profiled rail guide (10) with a guide rail as the first device component (15) and a guide carriage or guide block as the second device component (20).

37. The linear motion device according to claim 35, which is realized in the form of a ball screw with a spindle as the first device component and a spindle nut as the second device component, wherein the apparatus for generating a static magnetic field is arranged stationarily to the spindle nut.
